(19) United States
(12) Patent Application Publication
(10) Pub. No.: US 2026/0287916 A1
(43) Pub. Date: Sep. 24, 2026

(54) ACTUATOR FOR CAMERA

(71) Applicant: JAHWA Electronics Co., Ltd., Cheongju-si (KR)

(72) Inventors: In Cheol HONG, Cheongju-si (KR); Jin Tae KIM, Cheongju-si (KR); Yong Su LEE, Cheongju-si (KR)

(73) Assignee: JAHWA electronics Co., Ltd., Cheongju-si (KR)

(21) Appl. No.: 19/237,477

(22) Filed: Jun. 13, 2025

(30) Foreign Application Priority Data
Mar. 18, 2025 (KR) 10-2025-0034650

(51) Int. Cl. G02B 27/64; G03B 5/00; G03B 13/36

(52) U.S. Cl. CPC G02B 27/646; G03B 5/00; G03B 13/36; G03B 2205/0015; G03B 2205/0069

(57) ABSTRACT

Disclosed is an actuator for a camera, which includes a first frame configured to move in a plane direction perpendicular to an optical axis; at least one first magnet installed in the first frame; at least one second magnet installed in the first frame so as to be perpendicular to the at least one first magnet; a second frame configured to support a movement of the first frame; a plurality of first hall sensors arranged to face the at least one first magnet at different positions; and a first yoke made of magnetic material and installed in the second frame so as to face the at least one first magnet. In this case, the first yoke includes first and second parts spaced apart along a longitudinal direction of the at least one first magnet and having the same size.

### TECHNICAL FIELD

The present disclosure relates to an actuator for a camera, and more specifically, to an actuator for a camera, which may improve driving precision of the OIS through structural improvement of a yoke that generates an attractive force on a magnet.

### BACKGROUND ART

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

OIS compensates for camera shake by moving a mover equipped with a lens or image sensor relative to a stator in two directions, namely the first direction and/or the second direction, perpendicular to the optical axis.

In the conventional actuator, an intermediate mover (middle guide) is applied between the mover and the stator to enable independent movement in the first direction and the second direction, and a structure in which balls are disposed between the mover and the intermediate mover and between the intermediate mover and the stator is mainly applied.

In the conventional actuator, the mover, the intermediate mover, and the stator have a stacked structure, and balls are disposed between them, so that the height increases based on the optical axis direction.

Since the actuator for the camera is installed to stand upright on the main board of a portable terminal such as a smartphone, an increase in the height of the actuator means an increase in the thickness of the portable terminal. Therefore, the conventional actuator does not conform to the slimming trend of portable terminals and has the problem of low space utilization.

To solve this problem, there is disclosed a structure that moves the mover in a plane direction perpendicular to the optical axis with respect to the relative stator without an intermediate mover. An actuator with this structure has the advantage of being able to reduce the height of the actuator since the balls only need to be disposed between the mover and the relative stator without stacking two types of balls that guide each direction of movement vertically.

However, this actuator has no structure for guiding the linear movement of the mover, so the mover may rotate due to various causes such as external force. Since the OIS is implemented by linearly moving the mover equipped with a lens, etc. in a combined direction of the first direction and the second direction that are perpendicular to each other, the driving precision of the OIS may deteriorate if the mover rotates in this way.

To solve this problem, a yoke that generates an attractive force on the driving magnet installed in the mover is installed in the relative stator. This yoke may also perform a kind of centering function that induces the mover to return to the default position when the OIS operation is terminated.

The magnetic yoke installed in the relative stator to suppress the rotational component, etc., may affect the magnetic field of the magnet, such as through magnetic field shielding, and thus may cause disturbance in the magnetic field detection of the Hall sensor that detects the magnetic field of the magnet for OIS control.

This disturbance phenomenon may be partially resolved through the compensation algorithm of the operation drive, but this method is difficult to use as a fundamental solution since it is a post-processing method, and immediate responsiveness deteriorates because the operation processing must be performed.

Since the OIS continuously moves the mover minutely, this response time delay may cause or aggravate posture errors such as rotation or tilt of the mover, which may also have a negative effect on the overall operating precision of the OIS.

### DISCLOSURE

### Technical Problem

The present disclosure is designed to solve the problems of the related art, and therefore the present disclosure is directed to providing an actuator for a camera, which may implement the processing for detecting a rotational component of a mover and correcting the rotational component more quickly and precisely through structural improvement of a yoke.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

### Technical Solution

An actuator for a camera according to an embodiment of the present disclosure may comprise a first frame configured to move in a plane direction perpendicular to an optical axis; at least one first magnet installed in the first frame; at least one second magnet installed in the first frame so as to be perpendicular to the at least one first magnet; a second frame configured to support a movement of the first frame; a plurality of first hall sensors arranged to face the at least one first magnet at different positions; and a first yoke made of magnetic material and installed in the second frame so as to face the at least one first magnet.

In this case, the first yoke of the present disclosure may include first and second parts spaced apart along a longitudinal direction of the at least one first magnet and having the same size.

Depending on an embodiment, the first and second parts of the first yoke of the present disclosure may be arranged symmetrically with respect to a longitudinal center of the at least one first magnet.

In addition, the actuator according to an embodiment of the present disclosure may further comprise a second yoke made of magnetic material and installed in the second frame so as to face the at least one second magnet, and in this case, the second yoke may include first and second parts spaced apart along a longitudinal direction of the at least one second magnet and having the same size.

Preferably, the actuator according to an embodiment of the present disclosure may further comprise first and second coils arranged to face the at least one first magnet at different positions and independently driven; and third and fourth coils arranged to face the at least one second magnet at different positions and driven in conjunction with each other.

In addition, the actuator according to an embodiment of the present disclosure may further comprise a second hall sensor facing at least one second magnet, and the third coil of the present disclosure may be larger than the fourth coil in size facing the at least one second magnet.

In this case, the second hall sensor of the present disclosure may be disposed in an inner space of the third coil at a position biased toward the fourth coil.

Depending on an embodiment, the actuator according to an embodiment of the present disclosure may further comprise a third magnet installed in the second frame; a housing configured to support a movement of the second frame in an optical axis direction; an AF coil facing the third magnet; a first ball arranged between the first frame and the second frame; and a second ball arranged between the second frame and the housing.

### Advantageous Effects

According to an embodiment of the present disclosure, since OIS is implemented without adding a middle guide or other additional configurations equivalent thereto, the structure and shape of the entire actuator may be configured in a more space-intensive form, so the actuator may be further optimized for slimming down mobile terminals, etc.

According to an embodiment of the present disclosure, since the yoke that generates the attractive force on the magnet is divided into two or more parts and arranged, rotational component suppression may be effectively implemented.

According to an embodiment of the present disclosure, since the divided yokes are arranged to have positional consistency with a plurality of hall sensors, the sensing accuracy of the hall sensors and the driving precision of the operation drive based on the hall sensors may be improved.

According to an embodiment of the present disclosure, the coil unit for correcting the rotation component is configured with a plurality of coils that are driven independently, and the coil unit for increasing the driving force is configured with a plurality of coils that are driven in conjunction, thereby increasing the precision and efficiency of both the basic drive of the OIS and the drive for rotation correction.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a camera according to a preferred embodiment of the present disclosure,

FIG. 3 is a drawing for illustrating a configuration for driving the movement of a first frame,

FIG. 4 is a cross-sectional view showing the internal structure of the actuator for a camera according to an embodiment of the present disclosure,

FIG. 5 is a drawing for illustrating the relationship between a coil, a magnet, and a position sensor (hall sensor),

FIG. 6 is a drawing for illustrating a yoke according to an embodiment of the present disclosure,

FIG. 7 is a bottom view for illustrating the positional relationship between a magnet and a yoke,

FIG. 8 is a drawing for illustrating a first yoke according to an embodiment of the present disclosure, and

FIG. 9 is a drawing for illustrating an embodiment of a second coil and a second hall sensor according to the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

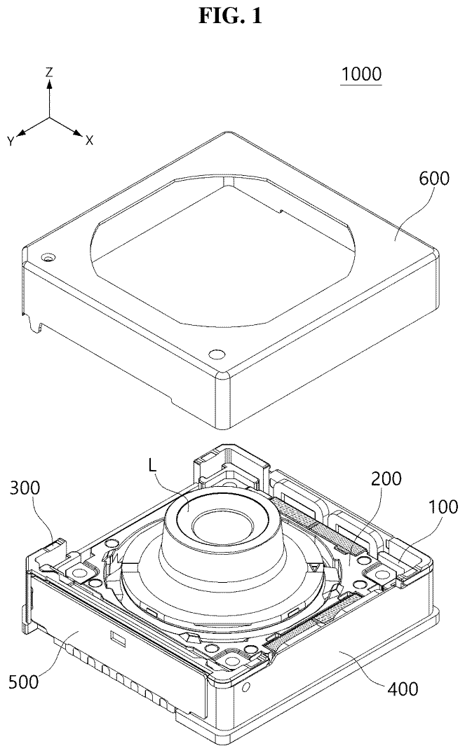

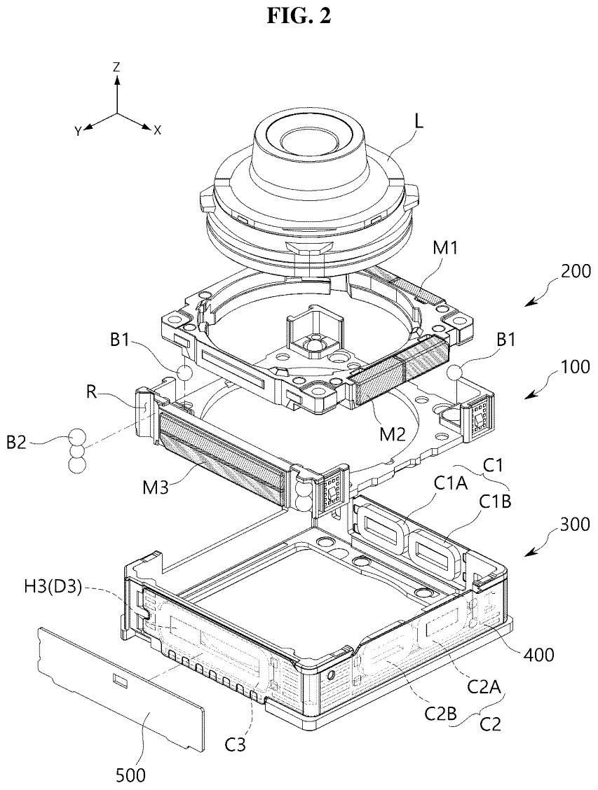

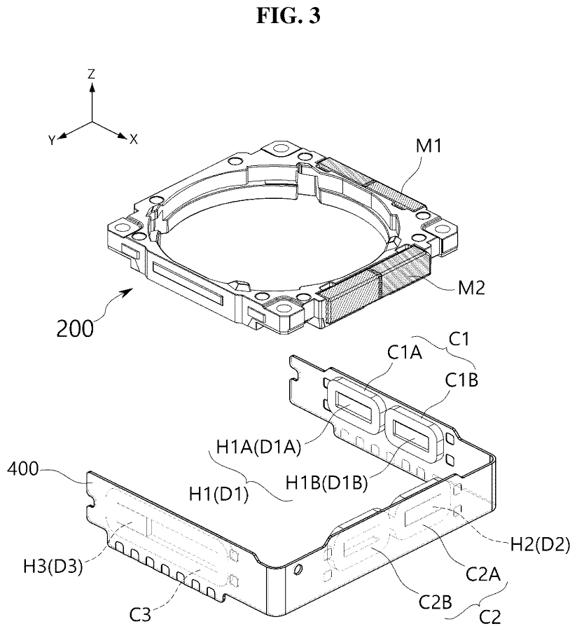

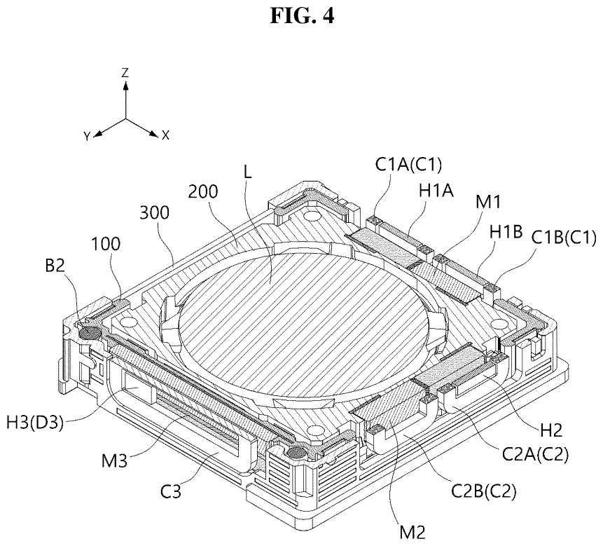

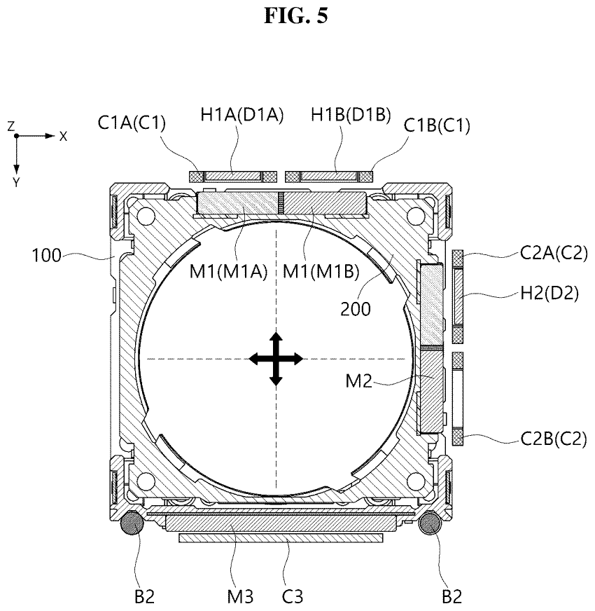

FIGS. 1 and 2 are diagrams showing the overall configuration of an actuator 1000 for a camera (hereinafter, referred to as an ‘actuator’) according to the present disclosure, FIG. 3 is a drawing for illustrating a configuration for driving the movement of a first frame 200, FIG. 4 is a cross-sectional view showing the internal structure of the actuator 1000 according to an embodiment of the present disclosure, and FIG. 5 is a drawing for illustrating the relationship between a coil, a magnet, and a position sensor (hall sensor).

Hereinafter, the overall configuration of the present disclosure and the operational relationship in which AF and OIS are performed will first be described with reference to FIGS. 1 to 5, and the details of the yoke of the present disclosure, which performs the rotation suppression and position restoration functions of a first frame 200, which is a mover of the OIS, will be described later.

The actuator 1000 of the present disclosure illustrated in FIG. 1 and the attached drawings is an embodiment in which AF and OIS are implemented together, but it is obvious that the actuator 1000 of the present disclosure may be implemented as an actuator only for OIS depending on the embodiment.

Also, the actuator 1000 of the present disclosure may be implemented as a standalone device, and may also be implemented in the form of a camera module including an image sensor (not shown).

As shown in FIG. 1 or the like, the actuator 1000 of the present disclosure may include a first frame 200, a second frame 100, and a housing 300.

The Z-axis direction shown in FIG. 1 is an optical axis direction, which is a direction in which light enters a lens or lens assembly L, and corresponds to the direction in which the second frame (second carrier) 100 moves forward and backward when AF is driven. Also, the X-axis and Y-axis, which are perpendicular to the optical axis, correspond to the direction in which the first frame (first carrier) 200 moves when OIS is driven.

In the following description of the embodiments of the present disclosure, one of two directions perpendicular to the optical axis is referred to as the first direction (Y-axis direction) and the other as the second direction (X-axis direction). However, this is only an example based on a relative viewpoint, and it is obvious that either the X-axis direction or the Y-axis direction can be the first direction and the other can be the second direction.

The axes shown in the drawings, terms referring to the axes, and terms such as “upper”, “lower”, “front”, “rear”, “vertical”, “horizontal”, or the like described with respect to the axes are intended to present a relative standard for describing an embodiment of the present disclosure, and it is obvious that these terms are not intended to specify any direction or location on an absolute basis. Of course, these terms may vary relatively depending on the location of a target object, the position or direction of view, or the like.

The housing 300 of the present disclosure corresponds to a basic frame structure that accommodates internal components of the actuator 1000 according to the present disclosure, and a case 600 that functions as a shield can may be coupled thereto according to an embodiment.

The first frame 200 corresponds to an OIS carrier or OIS frame that moves on a plane (XY plane based on the drawing) perpendicular to the optical axis with the second frame 100 or the housing 300 as a relative stator. When a lens or image sensor is mounted on this first frame 200, OIS is implemented to eliminate external disturbance phenomena such as hand shaking by moving the lens L, etc. due to the movement of the first frame 200.

The first ball B1 may be disposed between the first frame 200 and the second frame 100. If the AF is not implemented integrally, the first ball B1 may be disposed between the first frame 200 and, for example, the housing 300 corresponding to the relative stator of the first frame 200.

If the first ball B1 is provided in this way, an appropriate gap is maintained between the first frame 200 and the second frame 100, and the first frame 200 may move more flexibly due to the minimized friction caused by the moving and rolling of the first ball B1, so that noise reduction, minimization of driving force, and driving precision may be further improved.

At least one of the second frame 100 and the first frame 200 may include a pocket portion that accommodates the first ball B1 and prevents the first ball B1 from being ejected externally.

A first magnet M1 facing the first coil unit C1 and a second magnet M2 facing the second coil unit C2 may be installed on the first frame 200. For directional control, it is preferable that the first and second magnets M1 and M2 are arranged at right angles to each other.

If power of an appropriate magnitude and direction is supplied to the first coil unit C1 through the control of the first operation drive D1, a magnetic force (electromagnetic force) is generated between the first magnet M1 installed in the first frame 200 and the first coil unit C1, and the first frame 200 moves in the first direction (Y-axis direction) using this generated magnetic force as a driving force with the second frame 100 or the housing 300 as a relative stator. Through this movement control, external disturbances such as shaking in the Y-axis direction are corrected.

The first magnet M1 may be a single magnet as shown in the drawing, or may include multiple magnets. If the first magnet M1 includes multiple magnets, it is preferable that the magnets are provided at positions that are symmetrical in the left and right direction. The second magnet M2 is also the same.

If power of an appropriate magnitude and direction is supplied to the second coil unit C2 through the control of the second operation drive D2, a magnetic force (electromagnetic force) is generated between the second magnet M2 installed in the first frame 200 and the second coil unit C2, and the first frame 200 moves in the second direction (X-axis direction) using this generated magnetic force as a driving force with the second frame 100 or the housing 300 as a relative stator. The X-axis direction OIS is implemented by this movement control.

According to the embodiment, position sensors H1 and H2 for detecting the position, movement direction, movement size, etc. of the first frame 200 may be further included. If the position sensor detects the position, etc. of the first frame 200 and transmits a corresponding signal to the operation drive (control unit), the operation drive controls power of the corresponding magnitude and direction to be supplied to the coil unit.

The position sensor may be implemented as a hall sensor that detects changes in the magnitude or/and direction of a magnetic field of a magnet existing within a detection area using the hall effect and outputs an electrical signal accordingly.

The first hall sensor (first position sensor) H1 of the present disclosure is configured to detect the magnitude of a magnetic field that changes depending on the position of the first magnet M1, etc., and output a corresponding signal.

If the first hall sensor H1 detects the position of the first magnet M1 installed in the first frame 200 and outputs a corresponding signal to the first operation drive D1, the first operation drive D1 controls power of the corresponding magnitude and direction to be supplied to the first coil unit C1.

The first hall sensor H1 may include a plurality of hall sensors H1A, H1B arranged to face the first magnet M1 at different positions so as to effectively detect the rotation component of the first frame 200.

As an example, FIG. 5 shows a left hall sensor H1A facing the left (based on FIG. 5) portion M1A of the first magnet M1 and a right hall sensor H1B facing the right portion M1B of the first magnet M1.

Correspondingly, the first operation drive D1 may also include a plurality of operation drives D1A, D1B, and the first coil unit C1 may also include a plurality of coils C1A, C1B independently controlled by the first operation drives D1A, D1B, respectively.

For the relative distinction of coils, the coils included in the first coil unit C1 are referred to as a first coil C1A and a second coil C1B.

If the rotation component of the first frame 200 is detected through detection of the plurality of first hall sensors H1A and H1B, each of the first operation drives D1A and D1B controls the magnitude of current supplied to the first coil C1A and the second coil C1B so that the rotation component of the first frame 200 may be corrected.

If the magnitude of the magnetic field detected by the plurality of first Hall sensors H1A and H1B is the same, this means that the first magnet M1, i.e., the first frame 200, moves linearly or maintains its position.

In contrast, if the magnitudes of the magnetic fields detected by the plurality of first hall sensors H1A and H1B are different, this means that there is a posture deformation due to the rotational component in the first frame 200.

In order to more effectively correct the rotational component of the first frame 200, it is preferable that the first coil C1A, which is a component of the first coil unit C1, is controlled by the first hall sensor H1A and the first operation drive D1A, and the second coil C1B, which is another component of the first coil unit C1, is controlled by the first hall sensor H1B and the first operation drive D1B. In other words, it is preferable that the first coil C1A and the second coil C1B are configured to be driven or controlled independently.

If a plurality of hall sensors are arranged to face the magnet at different positions in this way, that is, if at least one driving unit of the X-axis OIS and the Y-axis OIS includes a plurality of hall sensors arranged at different positions, it is desirable that the characteristics (direction, intensity, etc.) of the magnetic field acting on the individual hall sensors are configured to be symmetrical for stable operation of the OIS.

The second hall sensor (second position sensor) H2 of the present disclosure is configured to detect the magnitude of a magnetic field that changes depending on the position of the second magnet M2, etc., and output a corresponding signal.

In order to improve the precision of the rotation component detection of the first frame 200 or to supplement or complement the rotation component detection of the first frame 200, the second hall sensor H2 may also be implemented as a plurality of hall sensors, like the first hall sensor H1. According to an embodiment, as shown in the drawing, the rotation component detection of the first frame 200 may be configured to be implemented in either the first hall sensor H1 or the second hall sensor H2.

If the second hall sensor H2 detects the position of the second magnet M2 installed in the first frame 200 and outputs a corresponding signal to the second operation drive D2, the second operation drive D2 may control the power of the corresponding magnitude and direction to be cyclically supplied to the second coil unit C2.

It is preferable that the second coil unit C2 include a plurality of coils for driving efficiency and driving force enhancement as illustrated in the drawing. For the relative distinction of coils, the coils included in the second coil unit C2 are referred to as a third coil C2A and a fourth coil C2B.

The second frame 100 corresponds to a mover that implements AF by moving in the optical axis direction (Z-axis direction) with the housing 300 as a relative stator.

In order to guide the movement of the second frame 100 in the optical axis direction, at least one of the second frame 100 and the housing 300 may be provided with a rail R having a shape extending in the optical axis direction and on which the second ball B2 is arranged.

A third magnet M3 facing the AF coil C3 installed in the housing 300 is installed on the second frame 100. If power of an appropriate magnitude and direction is supplied to the AF coil C3 through detection by the AF hall sensor H3 and control by the AF operation drive D3, an electromagnetic force (magnetic force) is generated between the AF coil C3 and the third magnet M3, and the second frame 100 moves in the optical axis direction using this electromagnetic force as a driving force.

If the second frame 100 moves in the optical axis direction, the first frame 200 on which a lens, etc. is mounted also moves in the optical axis direction together with the second frame 100.

If the second frame 100 moves forward and backward in the optical axis direction in this way, the distance between the lens and an image sensor (not shown), such as a CCD (Charged-Coupled Device) or CMOS (Complementary Metal-Oxide Semiconductor) installed at the rear end of the actuator 1000 (based on the optical axis direction), is adjusted, thereby implementing an auto-focus function or a zoom function.

The actuator 1000 of the present disclosure may be provided in a housing 300 and include a yoke plate 500 that generates an attractive force on the third magnet M3.

Since the second frame 100 mediated by the second ball B2 is pulled toward the housing 300 (in the Y-axis direction based on the drawing) by the attractive force between the yoke plate 500 and the third magnet M3, point contact between the second ball B2 and the second frame 100 and between the second ball B2 and the housing 300 is continuously maintained.

In order to effectively implement linear guiding, it is preferable that the second ball B2 is provided in a form in which a portion thereof is accommodated in the rail R formed on at least one of the second frame 100 and the housing 300.

If the second ball B2 is provided in at least one of the second frame 100 and the housing 300 in this way, the second frame 100 may linearly move more flexibly with minimized friction due to the moving, rolling, etc. of the second ball B2.

It is preferable that the circuit board 400, on which the coils C1, C2, C3, the hall sensors H1, H2, H3, etc. are mounted, is provided in the housing 300 located at the outermost side of the actuator 1000 for interfacing with external devices, etc.

The first operation drives D1A and D1B may be implemented as independent electronic components, elements, etc., but may also be implemented in the form of a single electronic component (chip) integrated with the first hall sensor H1A and H1B through SOC (System On Chip), etc. In this regard, the drawing shows the first hall sensor H1A and the first operation drive D1A, as well as the first hall sensor H1B and the first operation drive D1B in the same configuration. The second operation drive D2 and/or AF operation drive D3 are also the same.

The operation drive may be equipped with the same number of individual hall sensors and implemented as a single chip with the individual hall sensors. However, depending on the embodiment, the operation drive may not be equipped with the same number of individual hall sensors through channel adjustment for electrical connection with the hall sensors, and may be implemented as a single chip with some of the individual hall sensors.

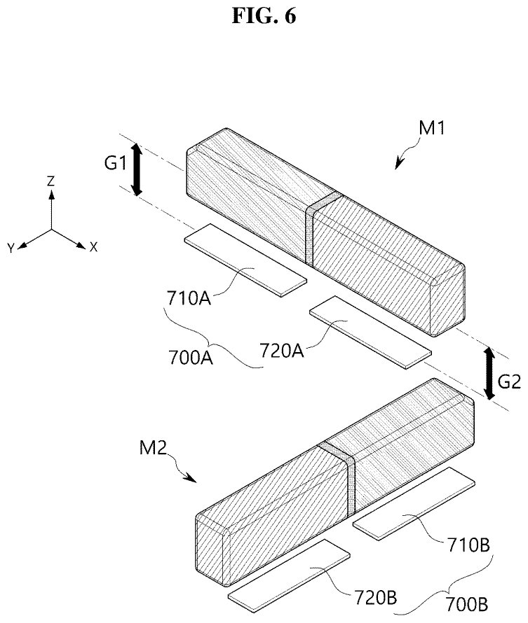

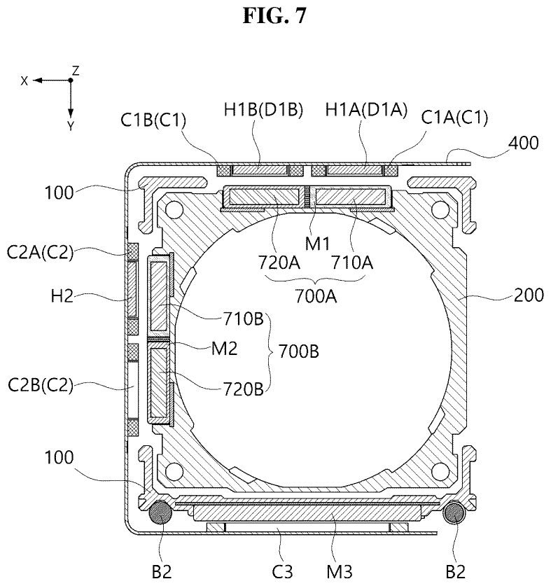

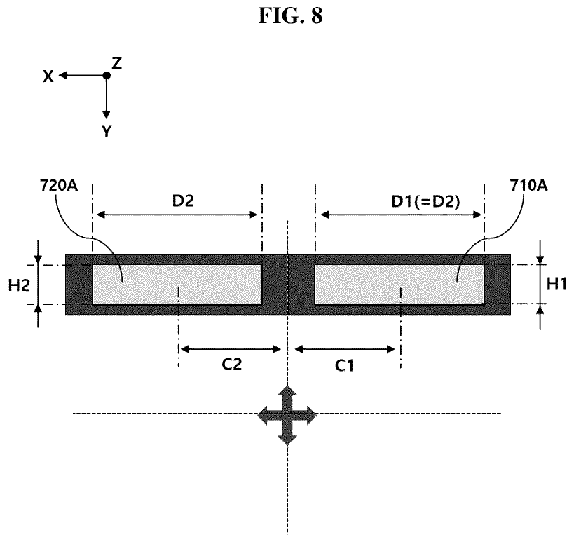

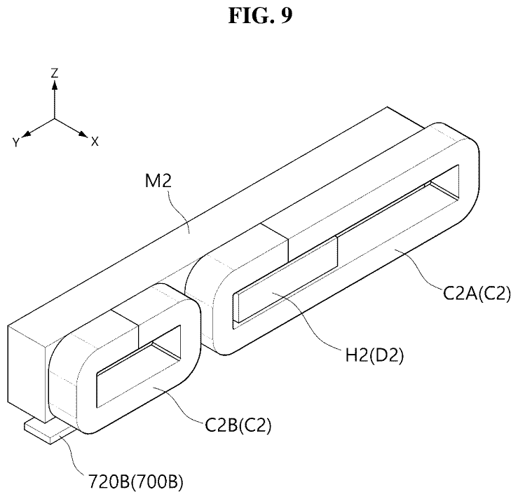

FIG. 6 is a drawing for illustrating yokes 700A, 700B according to an embodiment of the present disclosure, FIG. 7 is a bottom view for illustrating the positional relationship between magnets M1, M2 and yokes 700A, 700B, FIG. 8 is a drawing for illustrating a first yoke 700A according to an embodiment of the present disclosure, and FIG. 9 is a drawing for illustrating an embodiment of a second coil C2 and a second hall sensor H2 according to the present disclosure.

Hereinafter, the specific functions and structures of the yoke 700A and 700B according to an embodiment of the present disclosure are described in detail with reference to the attached drawings.

The yoke of the present disclosure is configured to be installed in the second frame 100, which is the relative stator of the first frame 200, and generates an attractive force on the magnets M1 and M2 installed in the first frame 200.

Specifically, the yoke may include a first yoke 700A and a second yoke 700B. The first yoke 700A is installed on the second frame 100 to face the first magnet M1 and is made of a magnetic body or magnetic material, etc. that generates an attractive force on the first magnet M1. The second yoke 700B made of a magnetic material, etc. is installed on the second frame 100 to face the second magnet M2 and generates an attractive force on the second magnet M2.

As explained above, the first ball B1 is disposed between the first frame 200, which is the mover of the OIS, and the second frame 100, which is the relative stator of the first frame 200, and an attractive force is applied to the first frame 200 and the second frame 100 by the yokes 700A and 700B and the magnets M1 and M2.

Therefore, the first frame 200 is in close contact with the second frame 100 (in the Z-axis direction based on the drawing) with the first ball B1 mediated between the first frame 200 and the second frame 100, so physical contact is maintained between the first frame 200 and the first ball B1, as well as between the first ball B1 and the second frame 100.

As shown in FIG. 6, the first yoke 700A may specifically include a first part 710A and a second part 720A that are spaced apart along the longitudinal direction (X-axis direction based on the drawing) of the first magnet M1.

Since the first part 710A and the second part 720A are magnetic bodies installed in the second frame 100 in a state of being spaced apart (G1, see FIG. 6) from the first magnet M1 in the downward direction of the first magnet M1, the first part 710A and the second part 720A may have the function of shielding a part of the magnetic field of the first magnet M1.

Therefore, the magnetic field of the first magnet M1 respectively recognized by the right (based on FIG. 7) first hall sensor H1A and the left first hall sensor H1B of the first hall sensor H1 is affected by the shielding area by each of the first part 710A and the second part 720A.

Therefore, if the physical and structural characteristics such as size, width, position, and posture of the first part 710A and the second part 700B are different from each other, the shielding areas or influences of the first and second parts 710A, 720A become different from each other, and as a result, the states or characteristics of the magnetic field detected by the right first hall sensor H1A and the left first hall sensor H1B become different from each other.

If the magnetic field characteristics detected by the plurality of first hall sensors H1A and H1B are different in this way, the precision of the driving control deteriorates because the different magnetic field characteristics must be continuously reflected in the driving control. In addition, since these different magnetic field characteristics change randomly and dynamically depending on the position of the first magnet M1, etc., the precision of rotation detection and rotation correction based on rotation detection may be significantly deteriorated.

In addition, if the magnetic field characteristics detected by the plurality of first hall sensors H1A and H1B are different, when controlling the magnitude and direction of the current supplied to the first coil C1A and the second coil C1B for first direction OIS, that is, to generate driving force between the first magnet M1 and the first coil unit C1, different magnetic field characteristics or environments must be reflected, and thus the inherent driving precision of the OIS may also deteriorate.

To solve this problem, it is desirable that the first part 710A and the second part 720A of the first yoke 700A are spaced apart from each other along the longitudinal direction of the first magnet M1, but configured to have the same physical characteristics (size, width, length, etc.) (D1=D2, H1=H2, see FIG. 8).

From a corresponding viewpoint, it is desirable that the first part 710A and the second part 720A of the first yoke 700A are arranged symmetrically with respect to the longitudinal center of the first magnet M1 (C1=C2, see FIG. 8).

In addition, if the specifications such as length, width, material, thickness, etc. of the first and second parts 710A, 720A included in the first yoke 700A correspond to each other, it is desirable that the gap G1 between the first part 710A of the first yoke 700A and the first magnet M1 correspond to the gap G2 between the second part 720A of the first yoke 700A and the first magnet M1.

The second yoke 700B may also be configured to include a first part 710B and a second part 720B, which are spaced apart from each other along the longitudinal direction of the second magnet M2 and have the same size (width). The configuration described above with respect to the arrangement, position, structure, etc. of the first yoke 700A may also be applied to the second yoke 700B.

It is preferable that the first coil C1A and the second coil C1B of the first coil unit C1 are arranged to face the first magnet M1 at different positions and are driven independently, and the third coil C2A and the fourth coil C2B of the second coil unit C2 are arranged to face the second magnet M2 at different positions and are driven in conjunction with each other.

According to this embodiment of the present disclosure, the first direction (Y-axis direction) OIS of the first frame 200 is implemented by the first coil unit C1 and the first magnet M1, and the second direction (X-axis direction) OIS of the first frame 200 is implemented by the second coil unit C2 and the second magnet M2, but the rotation correction of the first frame 200 may be implemented through independent control of the first coil C1A and the second coil C1B of the first coil unit C1, and the driving force of the second direction OIS may be strengthened.

For example, if the clockwise rotation component of the first frame 200 is detected, the magnitude of the current applied to the second coil C1B may be controlled to be relatively larger than the magnitude of the current applied to the first coil C1A, so that the rotation component of the first frame 200 may be corrected.

According to an embodiment, the clockwise rotation component of the first frame 200 may be controlled to be corrected by controlling an attractive force to be generated between the first coil C1A and the first magnet M1, and a repulsive force to be generated between the second coil C1B and the second magnet M2.

If the plurality of coils included in the second coil unit C2 are controlled to be interlocked, that is, to have the same directionality of the driving force, etc., it may be desirable to configure that the size of the third coil C2A facing the second magnet M2 is different from the size of the fourth coil C2B size facing the second magnet M2, as illustrated in FIG. 9.

Since a certain area at both ends of the magnet corresponds to a variable area where the magnitude of the magnetic field changes greatly, it is difficult to implement linear driving control. Therefore, if individual coils are configured so that the size or width facing the magnet is differentiated in this way, the variable area of the magnet facing the individual coil may be excluded as much as possible, thereby improving both driving force enhancement and linear control characteristics.

In this case, the second hall sensor H2 facing the second magnet M2 is preferably disposed in the inner space of the third coil C2A as shown in FIG. 9, but is preferably disposed at a position biased toward the fourth coil C2B.

According to this embodiment of the present disclosure, even if the first frame 200 rotates due to external factors, the second hall sensor H2 may face the area of the second magnet M2 where the change in position or posture is relatively smallest. Therefore, the magnetic field of the second magnet M2 may be detected in an environment where the influence of the rotation of the first frame 200 is minimized, thereby improving the driving precision of rotation detection and rotation correction.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

### REFERENCE SYMBOLS

1000: actuator
100: second frame
300: housing
500: yoke plate
700A: first yoke
720A: second part of the first yoke
710B: first part of the second yoke
C1: first coil unit
C2: second coil unit
C3: AF coil
B1: first ball
H1(2): first (second) hall sensor
D1(2): first (second) operation drive
200: first frame
400: circuit board
600: case
710A: first part of the first yoke
700B: second yoke
720B: second part of the second yoke
C1A(B): first (second) coil
C2A(B): third (fourth) coil
M1(2, 3): first (second, third) magnet
B2: second ball
H3: AF hall sensor
D3: AF operation drive

What is claimed is:

1. An actuator for a camera, comprising:
a first frame configured to move in a plane direction perpendicular to an optical axis;
at least one first magnet installed in the first frame;
at least one second magnet installed in the first frame so as to be perpendicular to the at least one first magnet;
a second frame configured to support a movement of the first frame;
a plurality of first hall sensors arranged to face the at least one first magnet at different positions; and
a first yoke made of magnetic material and installed in the second frame so as to face the at least one first magnet,
wherein the first yoke includes first and second parts spaced apart along a longitudinal direction of the at least one first magnet and having the same size.

2. The actuator for a camera according to claim 1,
wherein the first and second parts of the first yoke are arranged symmetrically with respect to a longitudinal center of the at least one first magnet.

3. The actuator for a camera according to claim 1, further comprising:
a second yoke made of magnetic material and installed in the second frame so as to face the at least one second magnet,
wherein the second yoke includes first and second parts spaced apart along a longitudinal direction of the at least one second magnet and having the same size.

4. The actuator for a camera according to claim 1, further comprising:
first and second coils arranged to face the at least one first magnet at different positions and independently driven; and
third and fourth coils arranged to face the at least one second magnet at different positions and driven in conjunction with each other.

5. The actuator for a camera according to claim 4, further comprising:
a second hall sensor facing at least one second magnet,
wherein the third coil is larger than the fourth coil in size facing the at least one second magnet, and
wherein the second hall sensor is disposed in an inner space of the third coil at a position biased toward the fourth coil.

6. The actuator for a camera according to claim 1, further comprising:
a third magnet installed in the second frame;
a housing configured to support a movement of the second frame in an optical axis direction;
an AF coil facing the third magnet;
a first ball arranged between the first frame and the second frame; and
a second ball arranged between the second frame and the housing.
